(19) United States
(12) Patent Application Publication
(10) Pub. No.: US 2018/0110246 A1
(43) Pub. Date: Apr. 26, 2018

(54) Method of Manufacturing Crispy Egg Roll

(71) Applicant: Jing-Yau Chung, Houston, TX (US)

(72) Inventor: Jing-Yau Chung, Houston, TX (US)

(21) Appl. No.: 15/793,627

(22) Filed: Oct. 25, 2017

Related U.S. Application Data
(60) Provisional application No. 62/412,418, filed on Oct. 25, 2016.

(51) Int. Cl. A23L 15/10

(52) U.S. Cl. CPC A23L 15/10; A23V 2300/38; A23V 2002/00

(57) ABSTRACT

The disclosure relates to an egg roll manufacturing process, having the steps of frying the egg roll, then coating the egg roll with a batter; and then chilling the egg roll. The disclosure also relates to an egg roll manufacturing process having the steps of frying the egg roll; then chilling the egg roll; then coating the egg roll with a batter; and then frying the chilled and battered egg roll.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

An egg roll is a well-known American food which consists of a filling wrapped by an egg roll skin. The filling can consist of the combination of vegetables and pork, beef or chicken or can be any other desirable combination of materials. The filling can also be ingredients of pizza or hamburger or even traditional food items normally served at breakfast such as bacon, cheese and egg etc. The egg roll skin is normally made of wheat flour with a small amount of corn starch, salt and optional egg. The term egg roll does not necessarily mean it contains egg as its ingredient, but probably the egg as an optional skin ingredient accounts for its name. Historically, the egg roll is an invention of the Chinese restaurant in the U.S. In the early times, most Chinese restaurants were owned by the Cantonese Americans', therefore the egg roll that they invented is also referred to as Cantonese style egg roll as opposed to the Asian style spring roll. The egg roll has since become a popular food available in most of the Chinese restaurants in the U.S. It is also a popular Asian food sold in the U.S. super markets. It is well known that the egg roll does not stay crispy a few minutes or so after frying although it is highly desirable to remain crispy for a long time after frying. For years, efforts had and have been made by the egg roll manufacturers like the one owned by the present inventor to utilize different methods to prolong the crispiness of the egg roll skin after frying, but so far none of those previous methods was successful.

### BRIEF SUMMARY

The present disclosure relates to a new egg roll manufacturing procedure which results in a crispy egg roll skin after frying and the skin remains crispy even hours after frying or baking as an optional reheating method. The egg roll filling can, by way of example, be a combination of vegetables and pork, beef or chicken, any other desirable combination of materials, including, but not limited to, ingredients of pizza or hamburger or even traditional food items normally served at breakfast such as bacon, cheese and egg etc.

The disclosure relates to an egg roll manufacturing process, having the steps of frying the egg roll, then coating the egg roll with a batter; and then chilling the egg roll. The disclosure also relates to an egg roll manufacturing process having the steps of frying the egg roll; then chilling the egg roll; then coating the egg roll with a batter; and then frying the chilled and battered egg roll.

### BRIEF DESCRIPTION OF THE DRAWING(S)

The exemplary embodiments may be better understood, and numerous objects, features, and advantages made apparent to those skilled in the art by referencing the accompanying drawing(s). These drawing(s) are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts a block diagram representing an exemplary embodiment of a crispy egg roll manufacturing process according to the improvements disclosed herein.

FIG. 2 depicts a block diagram representing an alternate exemplary embodiment of a crispy egg roll manufacturing process according to the improvements disclosed herein.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

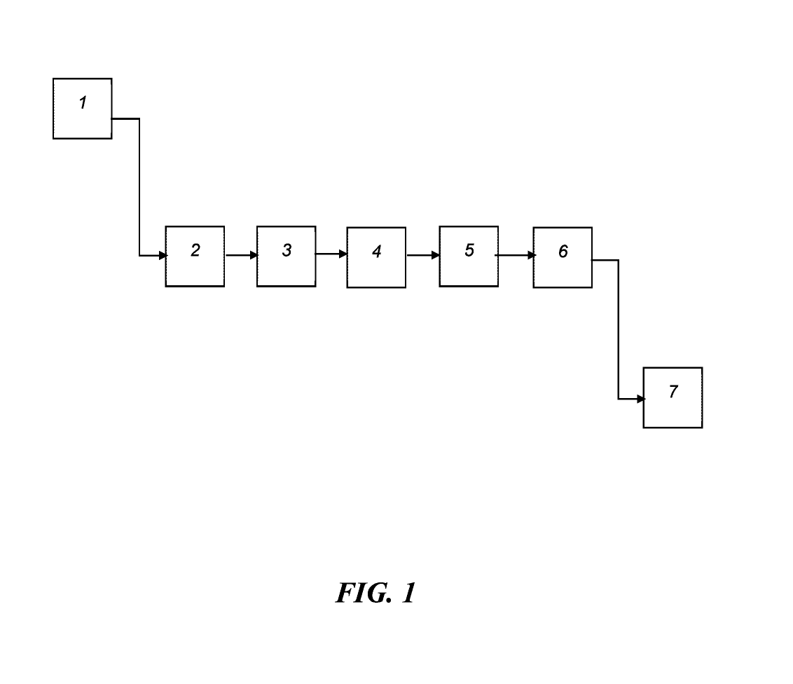

With reference to FIG. 1, a diagram representing the new egg roll manufacturing procedure is shown where 1 represents the wrapping of the egg roll either manually or automatically by means of an egg roll wrapping machine. 2 represents a fryer, 3 represents a quick chill system, 4 represents a batter coating system, 5 represents another fryer, 6 represents another quick chill system. The egg roll filling is wrapped into an egg roll wrapper at 1. The wrapped egg roll is then fried in 2 before it is quick frozen in 3. The frozen egg roll is then coated with flour based batter in 4 before it is fried in 5. The fried egg roll is then quick frozen in 6 before it is packaged in 7 as a finished frozen egg roll product.

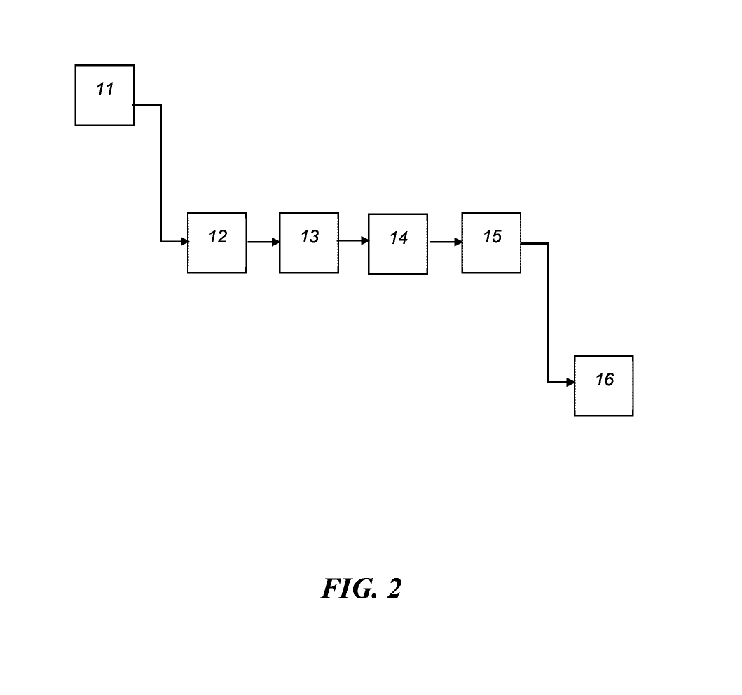

Performance of the above described procedure and/or steps in the exact sequence as recited with the exclusion of the wrapping of the egg roll in 1, the second quick freezing or chilling in 6, and the packaging in 7, may be critical to the preferred success of the final egg roll product for the purpose of achieving prolonged crispiness for the exemplary embodiment as described in FIG. 1. The noncritical procedure and/or steps of wrapping the egg roll in 1, the second quick freezing or chilling in 6, and packaging in 7 may or may not be performed, and alternately, may instead be performed by third parties. Furthermore, in alternative exemplary embodiments (as illustrated and described for FIG. 2), the quick frozen or chilling in 3 may be skipped to the next step of coating of batter in 4. The batter includes water, wheat flour, corn flour, sugar and baking powder in the order of percentage component weight.

With reference to FIG. 2, a diagram representing an alternative exemplary embodiment of the new egg roll manufacturing procedure is shown where 11 represents the wrapping of the egg roll either manually or automatically by means of an egg roll wrapping machine. 12 represents a fryer, 13 represents a batter coating system, 14 represents a quick chill system, 15 represents an optional fryer system, and 16 represents a packaging system. The egg roll filling is wrapped into an egg roll wrapper at 11. The wrapped egg roll is then fried in 12 before it is coated with a batter in 13. The wrapped and fried egg roll may be coated in 13 while the egg roll is still warm from frying. The batter in 13 may be a flour based batter. The coated egg roll is then frozen or chilled in 14 before it is optionally fried in 15 by the manufacturer or the consumer/customer. The manufacturer or consumer/customer may also optionally package the egg roll in 16. The egg roll may be packaged as a finished frozen egg roll product after freezing/chilling in 14, or the egg roll may be packaged as a finished fried egg roll product after the optional frying in 15. Performance of the above described procedure and/or steps in the exact sequence for FIG. 2 as recited with the exclusion of the wrapping of the egg roll in 11, the optional frying in 15 and the optional packaging in 16, may be critical to the preferred success of the final egg roll product for the purpose of achieving prolonged crispiness. The noncritical procedure and/or steps of FIG. 2 of wrapping of the egg roll in 11, optional frying in 15 and optional packaging in 16 may or may not be performed, and alternately, may instead be performed by third parties. This process as shown and as described in FIG. 2 may result in a thinner coating on the finished egg roll product, as compared with the exemplary embodiment as described in FIG. 1.

The above chilling, quick chill or freezing steps may be accomplished with a cryogenic system, for example, using, for example, liquid nitrogen to quickly chill or freeze during the production or manufacturing process. In one working example, the egg roll is quick chilled or frozen to about minus twenty (−20) degrees Fahrenheit.

During the batter coating step or system 4 in FIG. 1 and the batter coating step or system 13 in FIG. 2, in the exemplary embodiments, the batter should be smoothly applied to the wrapped and chilled/frozen egg roll. A smooth and/or thin batter may be applied. The smooth and/or thin batter includes water, wheat flour, corn flour, sugar and baking powder in the order of percentage component weight. The coating may have a clean and smooth surface and prolonged crispiness.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An egg roll manufacturing process, comprising the steps of:
frying the egg roll;
coating the egg roll with a batter; and
chilling the egg roll.

2. The method according to claim 1, wherein the batter further comprises corn flour.

3. The method according to claim 2, wherein the batter further comprises wheat flour.

4. The method according to claim 3, wherein the step of chilling the egg roll comprises quick chilling the egg roll with liquid nitrogen.

5. The method according to claim 4, wherein the step of quick chilling the egg roll with liquid nitrogen comprises quick chilling the egg roll to −20 degrees Fahrenheit.

6. The method according to claim 5, further comprising the step of frying the egg roll after the step of chilling the egg roll.

7. The method according to claim 6, wherein the step of frying the egg roll after the step of chilling the egg roll is performed by a customer.

8. The method according to claim 6, wherein the step of frying the egg roll after the step of chilling the egg roll is performed by a manufacturer.

9. The method according to claim 5, further comprising the step of packaging the egg roll after the step of chilling the egg roll.

10. The method according to claim 1, wherein the batter is comprised of water, wheat flour, and corn flour in the order of percentage component weight.

11. The method according to claim 1, wherein said step of coating the egg roll with the batter comprises coating with a thin batter in a smooth manner.

12. The method according to claim 1, wherein the batter is comprised water, wheat flour, corn flour, sugar and baking powder in the order of percentage component weight.

13. An egg roll manufacturing process, comprising the steps of:
frying the egg roll;
chilling the egg roll;
coating the egg roll with a batter; and
frying the chilled and battered egg roll.

14. The method according to claim 13, further comprising the step of wrapping the egg roll before the step of frying the egg roll.

15. The method according to claim 13, further comprising the step of re-chilling the egg roll after the step of frying the chilled and battered egg roll.

16. The method according to claim 15, further comprising the step of packaging the egg roll after the step of re-chilling the egg roll.

17. The method according to claim 13, wherein the step of coating the egg roll with a batter comprises the step of coating the egg roll with a smooth and thin batter.

18. The method according to claim 16, wherein the steps of chilling the egg roll and re-chilling the egg roll comprises freezing the egg roll and re-freezing the egg roll, respectively.

19. The method according to claim 15, wherein the steps of chilling the egg roll and re-chilling the egg roll are performed with a cryogenic system.

20. The method according to claim 14, further comprising the step of re-chilling the egg roll after the step of frying the chilled and battered egg roll.
